(19) United States
(12) Patent Application Publication
(10) Pub. No.: US 2015/0311501 A1
(43) Pub. Date: Oct. 29, 2015

(54) THREE-DIMENSIONALLY STRUCTURED LITHIUM ANODE

(71) Applicant: Robert Bosch GmbH, Stuttgart (DE)

(72) Inventors: Martin TENZER, Nuertingen (DE); Thomas WÖHRLE, Munchen (DE)

(21) Appl. No.: 14/699,727

(22) Filed: Apr. 29, 2015

(30) Foreign Application Priority Data
Apr. 29, 2014 (DE) 10 2014 207 999.

(51) Int. Cl. H01M 4/134; C25D 7/04

(52) U.S. Cl. CPC H01M 4/134; C25D 7/04; H01M 2004/027

(57) ABSTRACT

A method is provide for manufacturing a lithium anode and to a lithium anode for a lithium cell and/or a lithium battery. In order to improve the service life, performance capability and safety of a lithium cell and/or a lithium battery equipped with the lithium anode, the lithium anode includes a surface-structured current conductor and/or a surface-structured protective layer having at least one surface section circumscribed by a raised surface section, the surface structuring/structurings forming at least one cavity, and the at least one cavity being, in particular electrochemically, filled with anode active material. Also provided are a lithium cell and a lithium battery equipped with a lithium anode.

### FIELD OF THE INVENTION

The present invention relates to a method for manufacturing a lithium anode, to a lithium anode and a lithium cell equipped therewith and to a lithium battery.

### BACKGROUND INFORMATION

Undesirable, irreversible and damaging side reactions may occur on the anode surface between the anode active material and the electrolyte, or the species contained therein, of novel lithium cells and batteries, such as lithium-sulfur and lithium-oxygen/air cells and batteries, which use metallic lithium or a lithium alloy as the anode active material instead of graphite. In order to protect the anode active material from these reactions, a lithium ion-conducting, sealed and chemically as well as electrochemically stable protective layer may be applied to the anode surface.

German Published Patent Application No. 10 2011 089 174 describes a battery anode component, whose total lithium quantity is encapsulated in defined partitions to prevent a release of lithium in case of damage.

### SUMMARY

An object of the present invention is a method for manufacturing a lithium anode, in particular a three-dimensionally structured and/or protected lithium anode, for a lithium cell and/or a lithium battery.

In a method step a), in particular a current conductor and protective layer are provided. The current conductor and/or the protective layer may have a surface structuring, in which at least one raised surface section circumscribes at least one, in particular lower-lying or recessed, surface section.

In a method step b), the current conductor and the protective layer are in particular placed against each other. This may in particular take place in such a way that the surface structuring/structurings, for example of the current conductor and/or of the protective layer, form/forms at least one cavity.

In a method step c), the at least one cavity is in particular electrochemically filled with anode active material.

The term lower-lying or recessed is used in particular to describe the formation of a surface section with respect to a surface section which is raised in this regard, in particular without limitation with regard to the orientation of the same with respect to the gravitational direction and/or with regard to the manufacturing method or methods for forming the particular surface sections.

By accommodating the anode active material, for example metallic lithium or a lithium alloy, in the at least one cavity, formed by the surface structuring of the current conductor and/or the protective layer, the adhesion or adherence between the active material, the current conductor and/or the protective layer may advantageously be improved, and mechanical impairments of the protective layer, such as detaching (delaminating) and/or cracking of the protective layer, may be reduced or avoided. In particular, the three-dimensional surface structuring is able to deform, for example flexibly, and thereby maintain good adhesion between the active material, the current conductor and/or the protective layer, for example in all charge states, for example even when the volume and/or the quantity of the anode active material in the anode fluctuates drastically due to deposition or dissolution between charging and discharging of the cells, and in this way is also able to compensate for strong volume movements and/or quantity movements.

By electrochemically filling the anode active material into the at least one cavity, the adhesion between the active material, the current conductor and/or the protective layer may also be improved in a simple manner, and mechanical impairments of the protective layer, such as detaching (delaminating) and/or cracking of the protective layer, may be reduced or avoided. This may be explained by the fact that the electrochemical filling of the at least one cavity fills exactly the amount or the volume of anode active material into the at least one cavity which the at least one cavity is able to accommodate in the charged state, in which the anode active material generally has a greater volume (than in the uncharged state), for example maximally.

By improving the adhesion between the active material, the current conductor and/or the protective layer and reducing the mechanical impairments of the protective layer, the service life, performance capability and safety, and in particular also the cycle stability, of a lithium cell or lithium battery equipped with the lithium anode may be advantageously increased.

Advantageously, such a lithium anode may be used, for example in all secondary and primary lithium cells and/or batteries which include or use metallic lithium (lithium metal anode) or a lithium alloy (lithium alloy anode).

The anode active material may in particular include metallic lithium.

Within the scope of one specific embodiment, the anode active material is metallic lithium or a lithium alloy, for example a silicon-lithium alloy. For example, the anode active material may be metallic lithium. In this way, a high specific energy density may be advantageously achieved.

The at least one lower-lying (or recessed) surface section of the protective layer and/or of the current conductor may have a planar area, for example. For example, the at least one lower-lying surface section of the protective layer and/or of the current conductor may have a polygonal area, for example a rectangular, such as a square, a triangular or a hexagonal area. However, the at least one lower-lying surface section of the protective layer and/or of the current conductor may also have a different geometric shape, for example an at least partially round shape, for example an ovaloid shape, such as an oval, a circle and/or an ellipse, and/or a drop-like shape.

The at least one raised surface section of the protective layer and/or of the current conductor may, for example, surround the at least one lower-lying surface section of the protective layer or of the current conductor. For example, the at least one raised surface section of the protective layer and/or of the current conductor may circumscribe the at least one lower-lying surface section of the protective layer or of the current conductor—similarly to a boundary line. The area of the at least one lower-lying surface section of the protective layer and/or of the current conductor may in particular be enclosed between the at least one raised surface section of the protective layer and/or of the current conductor. For example, the at least one raised surface section of the protective layer and/or of the current conductor may have a mural or wall-like design. The space surrounded by the at least one raised surface section of the protective layer and/or of the current conductor and the at least one lower-lying surface section of the protective layer or of the current conductor may represent at least one cavity.

In particular, the at least one raised surface section of the protective layer and/or of the current conductor may circumscribe or surround a plurality of lower-lying surface sections of the protective layer or of the current conductor. The areas of the lower-lying surface sections of the protective layer and/or of the current conductor may in particular be enclosed between the at least one raised surface section of the protective layer or of the current conductor. For example, the at least one raised surface section of the protective layer and/or of the current conductor may be formed in a lattice shape from mural or wall-like raised structures. The spaces surrounded by the at least one raised surface section of the protective layer and/or of the current conductor and the lower-lying surface sections of the protective layer or of the current conductor may represent cavities. The lower-lying surface sections of the protective layer and/or of the current conductor may have planar areas, for example. For example, the lower-lying surface sections of the protective layer and/or of the current conductor may have a polygonal area, for example a rectangular, such as a square, a triangular and/or a hexagonal area. If necessary, the lower-lying surface sections of the protective layer and/or of the current conductor may also have two or more different polygonal areas, for example selected from the group of rectangles, such as squares, triangles and/or hexagons. The lower-lying surface sections of the protective layer and/or of the current conductor may also have a different geometric shape, for example an at least partially round shape, for example an ovaloid shape, such as an oval, a circle and/or an ellipse, and/or a drop-like shape. Such a surface structuring of the protective layer and/or of the current conductor may in particular be formed across the entire anode surface of the lithium anode to be manufactured.

In principle, it may be sufficient if only the protective layer has a surface structuring, in which at least one raised surface section circumscribes at least one lower-lying surface section, or if only the current conductor has a surface structuring, in which at least one raised surface section circumscribes at least one lower-lying surface section.

Within the scope of one further specific embodiment, however (at least) the protective layer has a surface structuring, in which at least one raised surface section circumscribes at least one lower-lying surface section. By introducing a surface structuring into the protective layer, the mechanical stability of the protective layer may advantageously be increased, for example according to the principle of reinforcement ribs. In this way, advantageously an increase in the mechanical stability of the protective layer may be achieved per se, in addition to an improved adhesion, and mechanical impairments of the protective layer may thereby effectively reduced.

In particular, however, both the current conductor and the protective layer may have such a surface structuring.

Within the scope of one further specific embodiment, the protective layer and the current conductor thus each have a surface structuring, in which at least one raised surface section circumscribes at least one lower-lying surface section, for example a plurality of lower-lying surface sections. In this way, particularly good adhesion and compensation of volume movements and/or quantity movements may advantageously be achieved and mechanical impairments of the protective layer may be further reduced. For example, the at least one raised surface section of the protective layer and the at least one raised surface section of the current conductor may be designed offset from each other, or, for example in method step b), be situated offset from each other or placed against each other. The at least one raised surface section of the protective layer and the at least one raised surface section of the current conductor may in each case individually form cavities, which may overlap each other or open into each other, if necessary. In this way, it is possible to improve the adhesion and reduce mechanical impairments of the protective layer.

Within the scope of one further specific embodiment, however, in method step b) at least one raised surface section of the protective layer and at least one raised surface section of the current conductor are placed against each other and together form at least one shared cavity. For example, the surface-structured protective layer and the surface-structured current conductor may be applied on top of each other in such a way that the structurings together form (shared) cavities, in particular a plurality of (shared) cavities. In particular, the at least one raised surface section of the protective layer may designed to be, in particular essentially, congruent with the at least one raised surface section of the current conductor.

The electrochemical filling of the cavities in method step c) with the anode active material, for example metallic lithium, may take place during the first charging of a cell, for example, in particular as part of the formation of the cell. The anode active material to be electrochemically filled into the cavities may be supplied by a cathode, for example a lithiated cathode, for example which includes at least one lithiated transition metal oxide, such as lithium-manganese and/or lithium-nickel and/or lithium-cobalt oxide (LiNi/Mn/Co/O₂, LiCoO₂, LiMnO₂, LiNiO₂) etc.), and/or an electrolyte, for example a lithium salt-containing electrolyte, for example which includes at least one lithium conducting salt such as lithium hexafluorophosphate (LiPF₆).

Within the scope of one further specific embodiment, in method step b) the current conductor/protective layer system is thus assembled with a cathode which includes an oxidized form of the anode active material, in particular lithium ions, and/or an electrolyte which includes an oxidized form of the anode active material, in particular lithium ions, to form a cell, method step c) taking place by the first charging, in particular formation, of the cell. As a result of the first charging or formation of the cell, the oxidized form of the anode active material may be transported through the protective layer into the cavities and be reduced and deposited in the cavities. In this way, the cavities may advantageously be electrochemically filled with the anode active material in a particularly simple manner.

As an alternative, method step c) may also take place by applying the anode active material to the protective layer and electrochemically filling the cavities with the same. For example, in method step c), the anode active material may be placed onto the protective layer in the form of a foil, for example a lithium foil.

Within the scope of one further specific embodiment, in method step c) thus the anode active material is applied to, for example placed on, the protective layer, for example in the form of a foil. In particular, the anode active material, for example lithium, may be electrochemically transported through the protective layer (electrochemical transport).

For example, a voltage, for example a charge voltage, may be applied to the anode active material which is applied to the protective layer, for example in the form of a foil which is placed on the protective layer. As a result of the application of the voltage, the anode active material may be transported through the protective layer into the cavities and deposited in the cavities. For example, metallic lithium may be applied to, for example placed on, the protective layer as anode active material, for example in the form of a lithium foil.

Thereafter, the anode active material, for example the lithium foil, which has been applied to the protective layer, may be removed again.

Within the scope of one further specific embodiment, the method, in particular after method step c) thus furthermore includes method d): removing the anode active material applied to the protective layer, for example the foil placed on the protective layer.

The protected anode obtained in this way in the form of the current conductor/protective layer system electrochemically filled with anode active material, for example metallic lithium, may then be installed in a cell.

Within the scope of one further specific embodiment, the method, in particular after method step d), thus furthermore includes method step d′): installing the anode in the form of the electrochemically filled current conductor/protective layer system, in particular from method step d), in a cell.

The protective layer and/or the current conductor may be designed in the form of a continuous layer, for example. For example, the surface structuring of the protective layer and/or of the current conductor, in particular in method step a), may be formed using rolling and/or embossing, in particular with the aid of a structured, for example embossed, roller, or using deep drawing or using chemical etching. In order to achieve a preferably high mechanical stability, the protective layer and/or the current conductor may in particular be designed without predetermined breaking points.

The current conductor may in particular be formed of an electrically conductive material. For example, the current conductor may be formed of a metallic material.

Within the scope of one further specific embodiment, the current conductor is made of copper. Copper advantageously has a good electrical conductivity, is comparatively cost-effective and may be shaped particularly well using rolling and/or embossing. For example, the current conductor may be formed of a copper foil.

Within the scope of one further specific embodiment, the protective layer is lithium ion-conducting. In particular, the protective layer may be a sealed, in particular fluid-tight and/or gas-tight, lithium ion-conducting layer. The protective layer may in particular be formed of one or multiple chemically and electrochemically stable materials.

Within the scope of one further specific embodiment, the protective layer is made of a ceramic and/or polymeric, in particular lithium ion-conducting material, and/or of a composite or multi-layer concept made up of such materials.

Method steps b) and/or c) may in particular be carried out under a protective gas atmosphere and/or in a vacuum. In this way, side reactions of the anode active material filled into the cavity may advantageously be avoided.

With respect to further technical features and advantages of the method according to the present invention reference is hereby made explicitly to the explanations provided in conjunction with the anode according to the present invention, the cell according to the present invention, and the battery according to the present invention, and to the figures and description of the figures.

Another object of the present invention is a lithium anode for a lithium cell and/or a lithium battery. For example, the lithium anode may be three-dimensionally structured and/or protected, in particular by a protective layer.

The lithium anode may in particular be manufactured using a method according to the present invention and/or include a current conductor and a surface-structured protective layer having at least one, in particular recessed, surface section circumscribed by a raised surface section, the current conductor and the protective layer abutting against each other, the surface structuring of the protective layer forming at least one cavity, and the at least one cavity being filled with anode active material, for example metallic lithium and/or a lithium alloy. As was already explained in conjunction with the method according to the present invention, electrochemical filling and/or a surface structuring of the protective layer may reduce mechanical impairments of the protective layer and improve the adhesion between the anode active material, current conductor and/or protective layer and may in this way increase the service life, performance capability and safety of a cell equipped therewith.

Within the scope of one specific embodiment, the current conductor is a surface-structured current conductor having at least one, in particular recessed, surface section circumscribed by a raised surface section. In this way, the adhesion may be further improved and mechanical impairments of the protective layer may be further reduced.

The at least one recessed surface section of the protective layer and/or the current conductor may in particular be recessed with respect to the (respective) raised surface section. In particular, the at least one recessed surface section of the protective layer and/or of the current conductor may be a surface section which is referred to as being lower-lying within the scope of the method.

Within the scope of one further specific embodiment, at least one raised surface section of the current conductor and at least one raised surface section of the protective layer abut against each other and together form at least one shared cavity. For example, the surface-structured protective layer and the surface-structured current conductor may be applied on top of each other in such a way that the structurings together form (shared) cavities, in particular a plurality of (shared) cavities. In particular, the at least one raised surface section of the protective layer may be designed to be, in particular essentially, congruent with the at least one raised surface section of the current conductor.

The protective layer and/or the current conductor may be designed in the form of a continuous layer, for example. In order to achieve a preferably high mechanical stability, the protective layer and/or the current conductor may in particular be designed without predetermined breaking points.

With respect to further technical features and advantages of the anode according to the present invention reference is hereby explicitly made to the explanations provided in conjunction with the method according to the present invention, the cell according to the present invention, and the battery according to the present invention, and to the figures and description of the figures.

The present invention further relates to a lithium cell and/or a lithium battery, which includes at least one lithium anode according to the present invention. The lithium battery may in particular include at least two lithium cells according to the present invention, for example which may each be equipped with a lithium anode according to the present invention. The at least two cells according to the present invention may in particular be interconnected in the lithium battery.

With respect to further technical features and advantages of the cell and battery according to the present invention reference is hereby explicitly made to the explanations provided in conjunction with the method according to the present invention and the anode according to the present invention, and to the figures and description of the figures.

### BRIEF DESCRIPTION OF THE DRAWINGS

FIGS. 1a through 1d show schematic cross sections to illustrate one specific embodiment of a method according to the present invention for manufacturing a three-dimensionally structured lithium anode.

FIG. 2 shows a schematic, perspective view of one specific embodiment of a three-dimensionally structured lithium anode according to the present invention.

### DETAILED DESCRIPTION

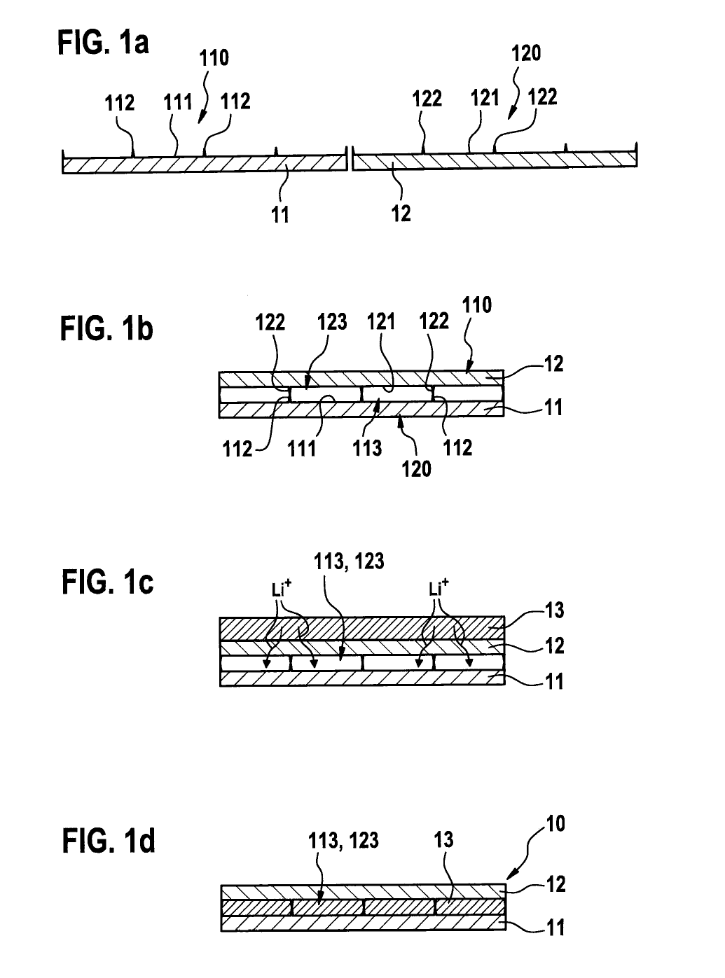

FIGS. 1a through 1d illustrate one specific embodiment of the method according to the present invention for manufacturing a three-dimensionally structured lithium anode 10 for a lithium cell and/or a lithium battery.

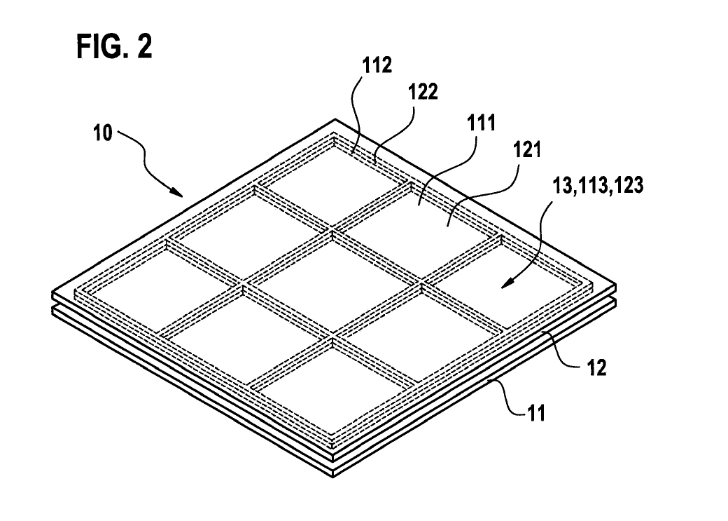

FIG. 1a shows that, within the scope of this specific embodiment, in a method step a) a surface-structured, in particular a three-dimensionally surface-structured, current conductor 11 and a surface-structured, in particular a three-dimensionally surface-structured, protective layer 12 are provided. Both current conductor 11 and protective layer 12 have a surface structuring 110, 120, in which 110, 120 mural or wall-like, raised surface sections 112, 122 circumscribe lower-lying or recessed surface sections 111, 121. Raised surface sections 112, 122 serve as boundary lines, which circumscribe lower-lying, planar areas 111, 121 enclosed in between. Areas 111, 121 may be square, for example, as illustrated in FIG. 2. Current conductor 11 and protective layer 12 are in each case designed in the form of continuous layers. Current conductor 11 may be a copper foil, for example. Protective layer 12 may in particular be made of a ceramic and/or polymeric, lithium ion-conducting material, and/or of a composite or multi-layer concept made up of such materials. Surface structurings 110, 120 of current conductor 13 and of protective layer 12 may be formed, for example, using rolling and/or embossing, for example with the aid of a structured or embossed roller, or using deep drawing or using chemical etching.

FIG. 1b shows that, in a method step b), the two surface-structured layers, namely current conductor 11 and protective layer 12, were applied on top of each other or placed against each other in such a way that surface structurings 110, 120 together result in shared cavities 113, 123. FIG. 1b illustrates that raised surface sections 122 of protective layer 12 are designed to be essentially congruent with raised surface section 112 of current conductor 11 and have been placed against each other in such a way that they 112, 122 together form shared cavities 113, 123.

FIG. 1c illustrates that, within the scope of this specific embodiment, the, in particular shared, cavities 113, 123 are electrochemically filled with anode active material 13, in particular metallic lithium, by applying, in a method step c), anode active material 13 in the form of a foil, in particular in the form of a lithium foil, onto protective layer 12, and applying a voltage to anode active material 13 which is applied to protective layer 12 and to current conductor 11. FIG. 1c illustrates that, by the application of the voltage, the anode active material is converted into an oxidized form, in particular into lithium ions, which may be transported through protective layer 12 into cavities 113, 123 and deposited there again in reduced form, in particular as metallic lithium.

FIG. 1d illustrates that, within the scope of this specific embodiment, anode active material 13 applied to protective layer 12 may be removed again in a method step d) after the electrochemical filling. Thereafter, resulting anode 10 may be installed in the form of electrochemically filled current conductor/protective layer system 11, 12, 13 into a cell in a method step d′) (not shown).

As an alternative to the electrochemical filling by applying and removing anode material 13 to and from protective layer 12, the electrochemical filling in method step c) may also be carried out during the first charging or as part of the formation of a cell using a lithiated cathode, for example which includes a lithiated transition metal oxide, such as lithium cobalt oxide (LiCoO₂).

In this way, it is advantageously possible to manufacture a lithium metal anode protected by protective layer 12 or a lithium alloy anode 10 having a three-dimensional structuring, which is characterized by improved adhesion between current conductor 11, anode active material 13, for example lithium, and protective layer 12, and by increased mechanical stability and a resulting increased service life, cycle stability, performance capability and safety, and which in particular is also able to withstand strong volume boosts during charging/discharging.

FIG. 2 shows a schematic, perspective view of one specific embodiment of a three-dimensionally structured lithium anode 10 according to the present invention, which may be manufactured or is manufactured by the specific embodiment of the manufacturing method according to the present invention described within the scope of FIGS. 1a through 1d.

FIG. 2 illustrates that lithium anode 10 includes a surface-structured current conductor 11, having a plurality of surface sections 111 which are circumscribed by a lattice-like, raised surface section 112 and recessed in particular with respect to raised surface section 112, and a surface-structured protective layer 12, having a plurality of surface sections 121 which are circumscribed by a raised surface section 122 and recessed in particular with respect to raised surface section 122. Current conductor 11 and protective layer 12 are designed in each case in the form of continuous layers. Raised surface sections 112, 122 serve as boundary lines, which circumscribe planar, square areas 111, 121 enclosed in between. FIG. 2 illustrates that raised surface sections 112, 122 of current conductor 11 and of protective layer 12 abut congruently against each other and together form a plurality of shared cavities 113, 123, which are filled with anode active material 13, in particular metallic lithium. FIG. 2 also illustrates that the composition described within the scope of FIGS. 1a through 1d may be formed in particular on the entire anode surface. A three-dimensionally structured lithium anode 10, illustrated in FIG. 2, may advantageously provide a safe, powerful, durable and cycle-stable lithium cell or lithium battery.

What is claimed is:

1. A method for manufacturing a lithium anode for at least one of a lithium cell and a lithium battery, comprising:
providing a current conductor and a protective layer, at least one of the current conductor and the protective layer having a surface structuring, in which at least one raised surface section circumscribes at least one lower-lying surface section;
placing the current conductor and the protective layer against each other, the surface structuring forming at least one cavity; and
electrochemically filling the at least one cavity with anode active material.

2. The method as recited in claim 1, wherein the protective layer has the surface structuring in which the at least one raised surface section circumscribes at least one lower-lying surface section.

3. The method as recited in claim 1, wherein the protective layer and the current conductor each has a respective surface structuring in which at least one raised surface section circumscribes at least one lower-lying surface section.

4. The method as recited in claim 1, wherein in the placing step the at least one raised surface section of the protective layer and the at least one raised surface section of the current conductor are placed against each other and together form at least one shared cavity.

5. The method as recited in claim 1, wherein the anode active material is one of metallic lithium and a lithium alloy.

6. The method as recited in claim 1, wherein in the placing step the current conductor and the protective layer are assembled into a system with at least one of:
a cathode which includes an oxidized form of the anode active material, and
an electrolyte which includes the oxidized form of the anode active material, in order to form a cell, and
wherein the filling step takes place by a first charging of the cell.

7. The method as recited in claim 1, wherein:
in the filling step the anode active material is applied onto the protective layer, and the anode active material is electrochemically transported through the protective layer.

8. The method as recited in claim 7, further comprising:
removing the anode active material applied to the protective layer.

9. The method as recited in claim 8, wherein the removing includes installing the anode in the form of an electrochemically filled current conductor/protective layer system in a cell.

10. The method as recited in claim 1, wherein at least one of:
the current conductor includes copper, and
the protective layer includes at least one of a ceramic material, a polymeric material, a composite of the ceramic material and the polymeric material, and a multi-layer concept made up of the ceramic material and the polymeric material.

11. The method as recited in claim 1, wherein the protective layer is lithium ion-conducting.

12. A lithium anode for at least one of a lithium cell and a lithium battery, manufactured using a method for manufacturing, comprising:
providing a current conductor and a protective layer, at least one of the current conductor and the protective layer having a surface structuring, in which at least one raised surface section circumscribes at least one lower-lying surface section;
placing the current conductor and the protective layer against each other, the surface structuring forming at least one cavity; and
electrochemically filling the at least one cavity with anode active material.

13. A lithium anode for at least one of a lithium cell and a lithium battery, comprising:
a current conductor; and
a surface-structured protective layer having at least one surface section circumscribed by a raised surface section, wherein:
the current conductor and the protective layer abut against each other,
the surface structuring of the protective layer forming at least one cavity, and
the at least one cavity is filled with anode active material.

14. The lithium anode as recited in claim 13, wherein the anode active material includes metallic lithium.

15. The lithium anode as recited in claim 13, wherein the current conductor is a surface-structured current conductor having at least one surface section circumscribed by a raised surface section.

16. The lithium anode as recited in claim 13, wherein at least one raised surface section of the current conductor and at least one raised surface section of the protective layer abut against each other and together form at least one shared cavity.

17. A device including at least one of a lithium cell and a lithium battery, the device including at least one lithium anode, comprising:
a current conductor; and
a surface-structured protective layer having at least one surface section circumscribed by a raised surface section, wherein:
the current conductor and the protective layer abut against each other,
the surface structuring of the protective layer forming at least one cavity, and the at least one cavity is filled with anode active material.

18. The method as recited in claim 6, wherein the oxidized form of the anode active material includes lithium ions.

19. The method as recited in claim 7, wherein the anode active material is applied in the form of a foil.
